(19) United States
(12) Patent Application Publication
(10) Pub. No.: US 2022/0165052 A1
(43) Pub. Date: May 26, 2022

(54) METHOD AND DEVICE FOR GENERATING DATA AND COMPUTER STORAGE MEDIUM

(71) Applicant: SenseBrain Technology Limited LLC, PRINCETON, NJ (US)

(72) Inventors: Yufei GAN, PRINCETON, NJ (US); Jun JIANG, PRINCETON, NJ (US); Jinwei GU, PRINCETON, NJ (US)

(21) Appl. No.: 17/583,338

(22) Filed: Jan. 25, 2022

(51) Int. Cl. G06V 10/774; G06T 7/50; G06V 10/22

(52) U.S. Cl. CPC G06V 10/7747; G06V 10/22; G06T 7/50

(57) ABSTRACT

A method and device for generating data and computer storage medium are provided. In the method, an original image is obtained and first depth information of the original image is determined; point spread functions for four phases matching the first depth information and a complete point spread function matching the first depth information are determined; the original image is processed according to the point spread functions for the four phases to obtain input image data, and the original image is processed according to the complete point spread function to obtain labeled image data; and the input image data and the labeled image data are determined as training data for training a neural network.

### BACKGROUND

In the related art, it is needed to process a raw image having a quad bayer array by using a remosaic network. For images captured by 2×2 On-Chip Lens (OCL) sensors, remosaic task becomes more challenging because of the existence of phase difference. For a process of training a remosaic network, it is needed to acquire input 2×2OCL image data with phase difference and labeled image data without phase difference corresponding to the input image. In a practical scenario, how to obtain a pair of input image data and labeled image data is an urgent technical problem to be solved.

### SUMMARY

The present disclosure relates to computer vision processing techniques, and more particularly, to a method and device for generating data and computer storage medium.

In an aspect, there is provided a method for generating data, including: obtaining an original image; determining first depth information of the original image; determining point spread functions for four phases matching the first depth information and a complete point spread function matching the first depth information, wherein the point spread functions for the four phases represent light field distribution information of images of the four phases acquired using the 2×2 OCL sensor, and the complete point spread function represents light field distribution information of an image acquired using the imaging sensor when there are one-to-one correspondences between pixels and lenses of the imaging sensor; processing the original image according to the point spread functions for the four phases to obtain input image data, and processing the original image according to the complete point spread function to obtain labeled image data; and determining the input image data and the labeled image data as training data for training a neural network.

According to another aspect, there is provided a device for generating data, including:

a processor; and a memory for storing instructions executable by the processor, wherein the processor is configured to: obtain an original image; determining first depth information of the original image; determine point spread functions for four phases matching the first depth information and a complete point spread function matching the first depth information, wherein the point spread functions for four phases represent light field distribution information of images of the four phases acquired using the 2×2 OCL sensor, and the complete point spread function represents light field distribution information of an image acquired using the imaging sensor when there are one-to-one correspondences between pixels and lenses of the imaging sensor; process the original image according to the point spread functions for the four phases to obtain input image data, and process the original image according to the complete point spread function to obtain labeled image data; and determining the input image data and the labeled image data as training data for training a neural network.

According to yet another aspect, there is provided a non-transitory computer storage medium having stored thereon a computer program which, when executed by a processor, executes a method for image processing, the method including: obtaining an original image; determining first depth information of the original image; determining point spread functions for four phases matching the first depth information and a complete point spread function matching the first depth information, wherein the point spread functions for the four phases represent light field distribution information of images of the four phases acquired using the 2×2 OCL sensor, and the complete point spread function represents light field distribution information of an image acquired using the imaging sensor when there are one-to-one correspondences between pixels and lenses of the imaging sensor; processing the original image according to the point spread functions for the four phases to obtain input image data, and processing the original image according to the complete point spread function to obtain labeled image data; and determining the input image data and the labeled image data as training data for training a neural network.

It is to be understood that both the foregoing general description and the following detailed description are exemplary and explanatory only and are not to limit the present disclosure.

### BRIEF DESCRIPTION OF THE DRAWINGS

The accompanying drawings, which are incorporated in and constitute a portion of the specification, illustrate embodiments consistent with the present disclosure and, together with the description, serve to illustrate the technical solution of the disclosure.

FIG. 1A is a schematic diagram of an imaging principle of a 2×2OCL sensor according to the related art;

FIG. 1B is a view showing an image acquired by an imaging sensor in a case where pixels are in one-to-one correspondences with lenses of the imaging sensor in the related art;

FIG. 1C is a view of an image acquired using a 2×2OCL sensor in the related art;

FIG. 2 is a schematic diagram of a remosaic process for an image having a quad bayer RGB array according to an embodiment of the present disclosure;

FIG. 3 is a first flowchart of a method for generating data according to an embodiment of the present disclosure;

FIG. 4A is a schematic diagram of a point spread function kernel for a first phase obtained based on an actual image acquired by a 2×2 OCL sensor according to an embodiment of the present disclosure;

FIG. 4B is a schematic diagram of a point spread function kernel of a second phase obtained based on an actual image acquired by the 2×2 OCL sensor according to an embodiment of the present disclosure;

FIG. 4C is a schematic diagram of a point spread function kernel of a third phase obtained based on an actual image acquired by the 2×2 OCL sensor according to an embodiment of the present disclosure;

FIG. 4D is a schematic diagram of a point spread function kernel of a fourth phase obtained based on an actual image acquired by the 2×2 OCL sensor according to an embodiment of the present disclosure;

FIG. 5 is a schematic diagram of generating a complete point spread function kernel according to an embodiment of the present disclosure;

FIG. 6 is a diagram of point spread function kernels of different depth information according to an embodiment of the present disclosure;

FIG. 7 is a schematic diagram of a point spread function kernel when a scene point is before and behind a focal plane, respectively, according to an embodiment of the present disclosure;

FIG. 8 is a second flow chart of a method for generating data according to an embodiment of the present disclosure;

FIG. 9 is a schematic diagram of a binary mask according to an embodiment of the present disclosure;

FIG. 10 is a third flow chart of a method for generating data according to an embodiment of the present disclosure;

FIG. 11 is a fourth flowchart of a method for generating data according to an embodiment of the present disclosure;

FIG. 12 is a schematic diagram of part of a pre-established mask library according to an embodiment of the present disclosure;

FIG. 13 is a fifth flowchart of a method for generating data according to an embodiment of the present disclosure;

FIG. 14 is a schematic diagram of a network structure of an upsampling neural network according to an embodiment of the present disclosure;

FIG. 15A is a schematic diagram of execution results of a remosaic task for playing cards obtained by a first method according to an embodiment of the present disclosure;

FIG. 15B is a schematic diagram of execution results of a remosaic task for playing cards obtained by a second method according to an embodiment of the present disclosure;

FIG. 16A is a schematic diagram of execution results of a remosaic task for a building obtained by a first method according to an embodiment of the present disclosure;

FIG. 16B is a schematic diagram of execution results of a remosaic task for a building obtained by a second method according to an embodiment of the present disclosure;

FIG. 17A is a schematic diagram of the highest resolution of an output image using a first method for processing challenging data according to an embodiment of the present disclosure:

FIG. 17B is a schematic diagram of the highest resolution of an output image using a second method for processing challenging data according to an embodiment of the present disclosure;

FIG. 18 is a schematic diagram a structure of a device for generating data according to an embodiment of the present disclosure.

### DETAILED DESCRIPTION

The present disclosure is described in further detail below with reference to the accompanying drawings and embodiments. It is to be understood that the embodiments provided herein are merely illustrative of the disclosure and are not intended to limit the disclosure. In addition, the following embodiments are provided for carrying out some of the embodiments of the present disclosure, rather than providing all embodiments for carrying out the present disclosure. The technical solutions described in the embodiments of the present disclosure may be carried out in any combination without conflict.

It is to be noted that in the embodiments of the present disclosure, the terms “comprise”, “include”, or any other variation thereof, are intended to encompass a non-exclusive inclusion, such that a method or device including a series of elements includes not only the elements expressly recited, but also other elements not expressly listed, or elements inherent to the method or device. Without more limitations, an element defined by “including a . . . ”, does not exclude that other relevant elements (e.g., a step in a method or unit in a device, e.g., the unit may be portion of a circuit, portion of a processor, portion of a program or software, etc.) exist in the method or device including the element.

For example, the method for generating data provided in the embodiments of the present disclosure includes a series of steps. However, the method for generating data provided in the embodiments of the present disclosure is not limited to the steps described. Similarly, the device for generating data provided in the embodiments of the present disclosure includes a series of modules. However, the apparatus provided in the embodiments of the present disclosure is not limited to include the modules as specifically described, and may further include the modules required for obtaining the related information or for processing based on the information.

In the related art, a 2×2 OCL sensor is a camera sensor capable of realizing full pixel phase detection auto focusing (PDAF), so that focusing accuracy can be improved.

Exemplarily, the 2×2 OCL sensor may include an optical layer and a semiconductor layer, and the optical layer includes a lens and a Color Filter (CF). The semiconductor layer is provided with a photodiode as a photoelectric conversion section. The lens is arranged in correspondence with the photodiode. The photodiode structure photoelectrically converts light input through an optical layer (i.e., a lens and a color filter) and corresponding to the color of the color filter. In the semiconductor layer, the photodiodes are separated by separate portions. In an embodiment of the present disclosure, the separation portion may be an element prepared based on a Reverse-side Deep Trench Isolation (RDTI) process.

In a practical scenario, the image acquired by the 2×2 OCL sensor has a quad bayer RGB (Red Green Blue) array. In embodiments of the present disclosure, the Color Filter Array (CFA) of the 2×2 OCL sensor may be represented by a quad bayer RGB array including 4×4 pixels, a quad bayer RGB array including a top left portion, a top right portion, a bottom left portion, and a bottom right portion. Each of the top left portion, the top right portion, the bottom left portion, and the bottom right portion each has 2×2 pixels.

Each portion of the quad bayer RGB array is divided into four phases, wherein the pixel of the upper left region of each portion of the quad bayer RGB array is a first phase, and the first phase can also be denoted as a phase 00; the pixel of the top right region of each portion of the quad bayer RGB array is a second phase, which may also be denoted as phase 01; the pixel of the bottom left region of each portion of the quad bayer RGB array is a third phase, which may also be denoted as phase 10; the pixel of the bottom right region of each portion of the quad bayer RGB array is the fourth phase, which can also be denoted as phase 11.

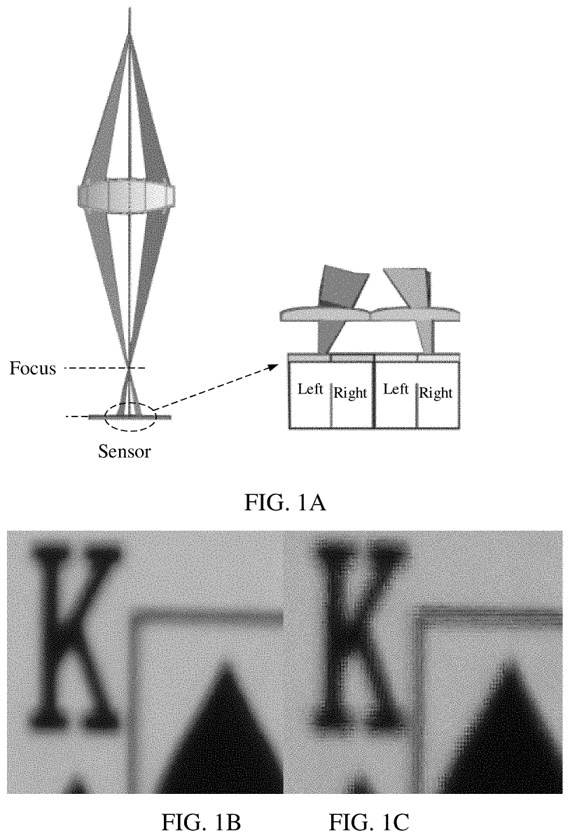

In the 2×2 OCL sensor, each group of 2×2 pixels corresponds to one microlens, which causes Phase Difference (PD) to occur. Here, the phase difference is the intrinsic disparity of the four phases coming from the structure of shared lens. It can be viewed as viewpoint difference among the four sub-images extracted for corresponding phases or as pixel shift in a small window, thereby causing artifacts such as duplicated edges without special processing. For example, the imaging principle of the 2×2OCL sensor is illustrated in FIG. 1A. FIG. 1B shows 1×1 OCL image, which is an image acquired by the imaging sensor in a case where pixels is in one-to-one correspondence with lenses of the imaging sensor, and FIG. 1C shows an image acquired by the 2×2OCL sensor. An imaging sensor represents a sensor for performing image acquisition. It can be seen that in FIG. 1C, compared to FIG. 1B, duplicated edges occur due to phase differences. The disparity level reflecting the degree of phase difference is variable and complex in images, and the disparity level is related to the distance of an object which is photographed from the focal plane. Generally, in the images, the relationship between the disparity levels of different pixels is complex, which makes it difficult to correct the phase difference.

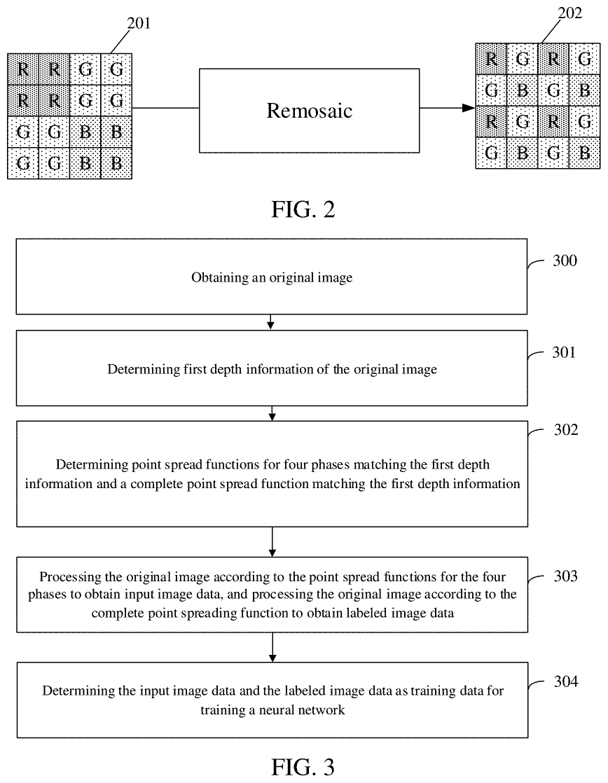

In a practical scenario, referring to FIG. 2, an image having a quad bayer RGB array 201 may be processed by using a remosaic network to obtain an image of the Bayer array 202. After obtaining the image of the Bayer array 202, the image of the Bayer array 202 may also be visually presented by image signal processing (ISP) techniques. The ISP is primarily a unit for processing signals output from front-end image sensors to match image sensors from different manufacturers. Here, the image having the quad bayer RGB array 201 is the image acquired by the 2×2 OCL sensor.

Exemplarily, the step of processing the image having the quad bayer RGB array 201 by using the remosaic network may include dividing the image having the quad bayer RGB array 201 into sub-images corresponding to four phases according to the phases of the pixels; converting each of the sub-images corresponding to the four phases into a corresponding RGB image; inputting the RGB images corresponding to the sub-images of the four phases to a trained up-sampling neural network, and processing the RGB images corresponding to the four sub-images with the trained up-sampling neural network to obtain an output image; converting the output image a bayer array image.

Here, the training data of the remosaic network may include input image data and labeled image data.

How to acquire a large amount of training data for the remosaic network is an urgent technical problem to be solved.

In view of the above technical problems, the technical solution of the embodiments of the present disclosure is proposed.

Embodiments of the present disclosure may be applied to a device for image processing, which may be implemented using at least one of a terminal and a server, and may operate with numerous other general-purpose or special-purpose computing system environments or configurations. Here, the terminal may be a thin client, a thick client, a handheld or laptop device, a microprocessor-based system, a set-top box, a programmable consumer electronics product, a network personal computer, a mini computer system, or the like. The server may be a mini computer system, a mainframe computer system, a distributed cloud computing technology environment including any of the above systems, or the like.

Electronic devices such as a terminal and a server may implement corresponding functions through execution of program modules. Generally, program modules may include routines, programs, target programs, components, logic, data structures, and the like. The computer system/server may be implemented in a distributed cloud computing environment in which tasks are performed by remote processing devices linked through a communication network. In a distributed cloud computing environment, program modules may be located on a local or remote computing system storage medium including a storage device.

Based on the application scenario described above, the embodiments of the present disclosure provides a method for image processing.

FIG. 3 is a first flow chart of a method for generating data according to an embodiment of the present disclosure. As illustrated in FIG. 3, the flow may include the following operations.

In step 300, an original image is obtained.

In some embodiments, the original image may be a locally stored image, an image acquired from networks, or an image acquired from a pre-established image library, and the depth information of the original image may be information specified by a user.

In some embodiments, the original image may be an image acquired by an image acquisition device.

In embodiments of the present disclosure, the number of original images may be plural.

In step 301, first depth information of the original image is determined.

In step 302, determining Point Spread Functions (PSFs) for four phases matching the first depth information of the original image and a complete point spread function matching the first depth information of the original image.

Here, the point spread functions for the four phases represent the light field distribution information of the images of the four phases acquired by the 2×2 OCL sensor, and the complete point spread function represents the light field distribution information of the image acquired by the imaging sensor when the pixels are in one-to-one correspondences with the lenses of the imaging sensor.

In an embodiments of the present disclosure, the light field distribution information represent the correspondences between the positions of pixels and light field intensities.

In an embodiment of the present disclosure, the point spread functions for four phases includes a point spread function for a first phase, a point spread function for a second phase, a point spread function for a third phase, and a point spread function for a fourth phase. The point spread functions for four phases and the complete point spread function can be visually rendered by the corresponding kernel.

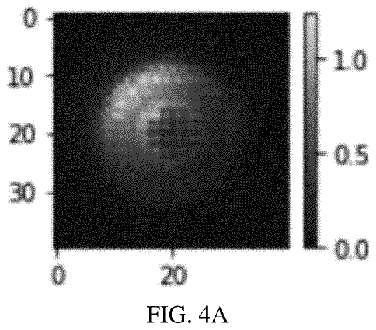

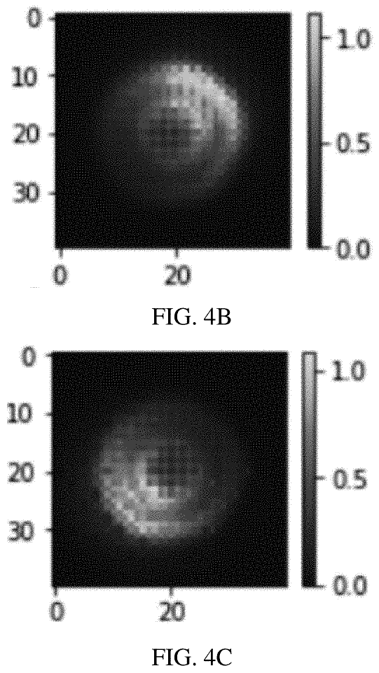

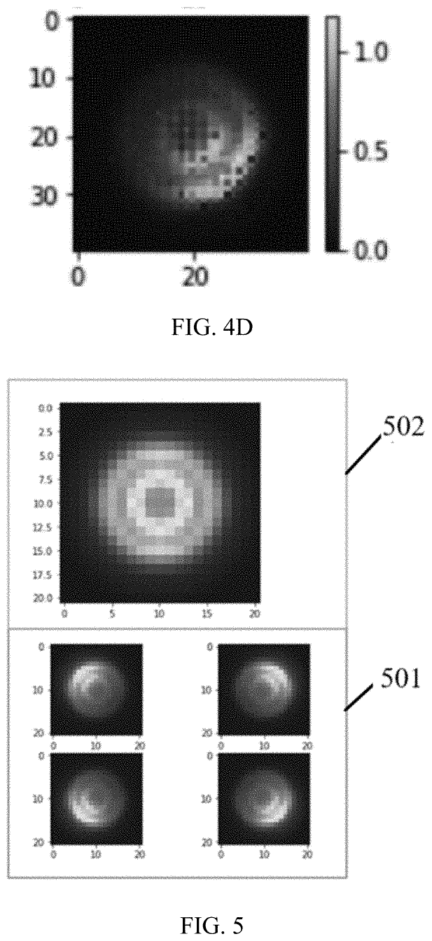

It will be appreciated that the phase difference in the image acquired by the 2×2 OCL sensor is due to the fact that each of the point spread function kernels for the four phases should ideally be equal to quarter circular image. Here, the point spread function kernels for the four phases should form a centrosymmetric relationship with respect to the center of the circle image. However, in a practical scenario, due to the presence of light leakage in the 2×2 OCL sensor, the point spread function kernels for four phases are not quarter circle images, but are the schematic diagrams of the point spread function kernels for four phases illustrated in FIGS. 4A to 4D.

It will be appreciated that the kernel of the complete point spread function should be similar to an average of the four-phase point spread function kernels, and therefore, referring to FIG. 5, the kernel 502 of the complete point spread function can be generated from the kernels 501 of the point spread functions for four phases.

In the embodiments of the present disclosure, the size of each point spread function kernel (including the point spread function kernels for four phases and the complete point spread function kernel) forms a linear relationship with its distance to the focal plane due to the optical principle of the lens in the imaging sensor. If an object is farther from the focal plane, the corresponding imaging result will be blurred, because the larger the point spread function kernel is, the more blurred the resulting imaging result will be.

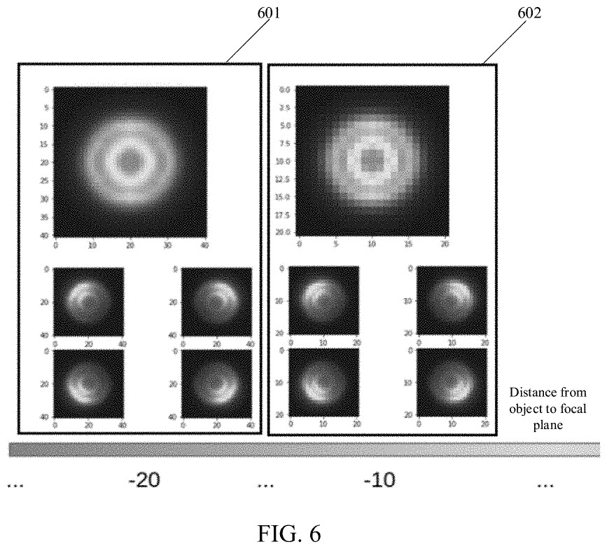

According to the relationship between the size of the point spread function kernel and the distance from the focal plane, the point spread function kernel matching different depth information can be generated. Here, the depth information represents the distance between the scene point (i.e., the object to be imaged) and the focal plane. Referring to FIG. 6, a first set of kernels 601 represents the point spread function kernels for four phases and a complete point spread function kernel when a distance between a scene point and a focal plane is 20. The first set of kernels 602 represents the point spread function kernels for four phases and the complete point spread function kernel when the distance between the scene point and the focal plane is 10. It can be seen that the size of the first set of kernels 601 is larger than the size of the second set of kernels 602.

In the embodiments of the present disclosure, the point spread function kernel is different when the scene point is before the focal plane and behind the focal plane, respectively.

In the related art, for the case where only two phases (i.e., left phase and right phase) are present in image, the optical model may be used to describe the point spread function kernel when the scene point is in the focal plane, before the focal plane, and after the focal plane, respectively. The point spread function kernel for each phase is different when the scene point is in the focal plane, before the focal plane, and after the focal plane, respectively.

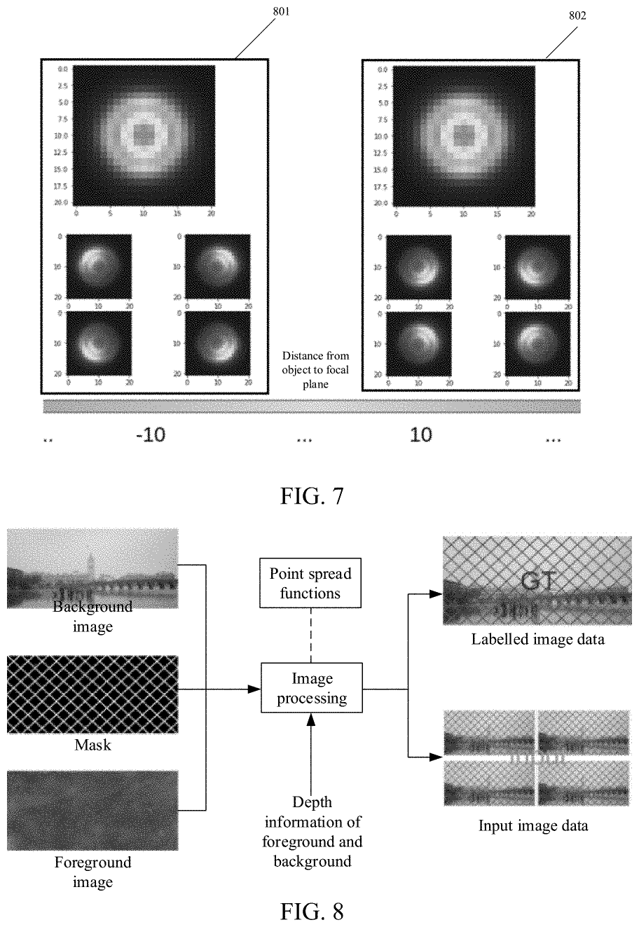

In the embodiment of the present disclosure, the point spread function kernel for each phase is different when the scene point is at the focal plane, before the focal plane, and after the focal plane, respectively, for the four-phase image. Referring to FIG. 7, the third set of kernels 801 represents the point spread function kernels for four phases and the complete point spread function kernel when the scene point is located behind the focal plane. The fourth set of kernels 802 represents the point spread function kernels for four phases and the complete point spread function kernel with the scene points before the focal plane.

Based on the content of the point spread function kernel described above, the kernel library may be established in advance, and the kernel library stores the point spread function kernels for four phases corresponding to scene points of different depth information when scene points are located before the focal plane and the complete point spread function kernels, and the point spread function kernels for four phases corresponding to scene points of different depth information when scene points are located at the focal plane and the complete point spread function kernels, and further stores the point spread function kernels for four phases corresponding to scene points of different depth information when scene points are located behind the focal plane and the complete point spread function kernels.

Thus, after determining the first depth information of the original image, the point spread function kernels for four phases matching the first depth information of the original image and the complete point spread function kernel can be selected from the pre-established kernel library, that is, the point spread functions for four phases matching the first depth information and the complete point spread function can be determined.

In step 303, processing the original image according to the point spread functions for four phases to obtain the input image data. The original image is processed according to the complete point spread function to obtain labeled image data.

In practical application, it is possible to perform convolution processing on the original image using the point spread function kernels for four phases, respectively, to obtain four blurred images; obtaining input image data from the four blurred images. Similarly, convolution processing may be performed on the original image using the the complete point spread function kernel to obtain labeled image data.

In step 304, the input image data and the labeled image data are determined as training data for training a neural network.

In some embodiments, the neural network may be a remosaic network or other neural network for image processing.

In some embodiments, after obtaining the input image data and the labeled image data for the neural network, the input image data and the labeled image data may be determined as training data for the neural network. The neural network is trained using the training data to obtain a trained neural network.

In some embodiments, after obtaining the input image data for the neural network, the input image data may be input to the neural network, and the input image data is processed by the neural network to obtain prediction data. Then, the network parameter value of the neural network may be adjusted, for training the neural network based on the prediction data and the labeled image data.

An implementation of adjusting the network parameter value of the neural network is to derive a loss of the neural network based on the prediction data and labeled image data. The network parameter value of the neural network is adjusted according to the loss of the neural network.

In the embodiment of the present disclosure, the steps of obtaining the labeled image data and the input image data, obtaining the prediction data, and adjusting the network parameter value of the neural network according to the prediction data and the labeled image data may be performed again if the adjusted neural network of the network parameter value does not meet the training end condition, and the adjusted neural network of the network parameter value is used as the trained neural network if the adjusted neural network of the network parameter value meets the training end condition.

Exemplarily, the training end condition may be that the processing of the image by the neural network after the adjusted network parameter value satisfies the set accuracy requirement. Here, the predetermined requirement for accuracy is related to the loss of the neural network. For example, the predetermined requirement for accuracy may be that the loss of the neural network is less than the predetermined loss.

Exemplarily, after obtaining the trained upsampling neural network, the images acquired by the 2×2 OCL sensors may be processed by the remosaic network.

It will be appreciated that the low resolution images of the four phases can be restored to a high resolution image by the trained remosaic network, facilitating completion of the remosaic task.

In practical applications, steps 300 to 304 may be implemented using a processor in an image processing device, which may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing Unit (CPU), a controller, a microcontroller, a microprocessor.

It will be appreciated that training data is important for the success of any data-driven method including deep learning. However, in the related art, high labor and time cost are required to obtain high-quality labeled image data, and in order to improve the training effect of the neural network, input image data (e.g., an image with complex texture) that is difficult to process for the neural network is required to be obtained. In practical scenarios, input image data that is difficult to process for neural network is generally difficult to obtain in large quantities. In the embodiment of the present disclosure, the original image may be processed according to the point spread function and the complete point spread functions for four phases that match the first depth information of the original image to obtain the input image data and the labeled image data for the neural network, that is, the input image data and the labeled image data of the pairwise may be easily obtained in the embodiment of the present disclosure, and the training data may be obtained without completely relying on the real image collected by the 2×2 OCL sensor, thereby saving the labor cost and the time cost of obtaining the training data.

Further, embodiments of the present disclosure explain the root cause of the phase difference in the image acquired by the 2×2 OCL sensor in accordance with the optical imaging principle of the 2×2 OCL sensor; point spread functions matching the depth information of the original image are obtained according to the root cause of the phase difference in the image acquired by the 2×2 OCL sensor, and a forward imaging model is proposed for generating input image data and labeled image data according to the obtained point spread function. Here, the forward imaging model is a model simulating the physical imaging process of the 2×2 OCL sensor.

For tasks such as demosaic or remosaic, it is needed to acquire input image data that is difficult to process for remosaic network to improve the performance of the remosaic network. The input image data, which is difficult to process by using the remosaic network, can be challenging data, which is often difficult to obtain in actual scenarios, but the forward imaging model based on the embodiments of the present disclosure can more easily generate challenging data.

Exemplarily, obtaining the original image may include determining at least two image layers having different depth information, selecting the image having the at least two image layers from a pre-established image library, and using the image having the at least two image layers as the original image.

In practical application, an image library including various types of images may be pre-established, the image library may include an RGB image library with challenging data. After determining the depth information of at least two image layers, images may be selected for the at least two image layers from the pre-established image library respectively, so that generation of the original image may be realized without acquiring real images by the imaging sensor, thereby facilitating the variety of the original images and facilitating the generation of a large amount of challenging input image data and labeled image data.

It will be appreciated that by images of at least two image layers, the original image can be made to better simulate a real life scene. When it is assumed that the original image includes only one layer of image and the layer of image is in the same depth, it is difficult to accurately process the actually acquired image having different depths using the remosaic network trained by the original image, for example, the image processed by the remosaic network may have a phenomenon that the region near the boundary between the foreground and background is missing.

In the embodiment of the present disclosure, the images of at least two image layers may be randomly selected from a pre-established image library, or the images of at least two image layers may be selected from a pre-established image library according to a user's image selection instruction.

Exemplarily, the at least two image layers described above may include foreground and background, and the depth information of the foreground is different from the depth information of the background. It can be seen that, in the embodiment of the present disclosure, the images for the foreground and the background can be selected respectively from the pre-established image library after determining the depth of the foreground and the depth of the background, so that the generation of the original image can be accurately realized without acquiring the real image through the imaging sensor.

Of course, in other embodiments, the original image may also include three image layers or more than three image layers.

Exemplarily, the respective depth information of at least two image layers may be information specified by a user or may be randomly determined information. When the respective depth information of at least two image layers are randomly determined information, in the embodiments of the present disclosure, image layers having various depth information by cyclically performing the step of acquiring the original image, thereby facilitating the multiplicity of the original images, thereby facilitating the generation of a large amount of input image data and labeling the image data.

Exemplarily, the step of processing the original image according to point spread functions for the four phases to obtain input image data may include: performing blurring processing on an image of each of the at least two image layers according to the point spread functions for four phases matching the depth information of the image layer to obtain four blurred images of the image layer; and obtaining the input image data according to four blurring images of each image layer.

As can be seen, the point spread functions for the four phases matching the depth information of the image of each image layer may represent the light field distribution information of the image of the image layer, and the image of the image layer is obtained according to the point spread functions for the four phases matching the depth information of the image of the image layer, and thus, the image of the image layer is closer to an image as actually captured. As such, it is advantageous to obtain input image data, that is closer to the image as actually captured, by performing blurring processing on an image of each image layer.

Exemplarily, obtaining the input image data according to four blurring images of each image layer may include: obtaining a sample image of the image layer by sampling the four blurred images; and selecting a first mask from a pre-established mask library, and obtaining a region image of each image layer by performing region image extraction on the sample image of the image layer according to the first mask; obtaining the input image data by synthetizing the region images of at least two image layers.

In an embodiment of the present disclosure, the first mask is used to extract regions of interest from the image of each of the at least two image layers.

Explanation will be made below by taking two image layers as an example.

When at least two image layers include a foreground and background, as illustrated in FIG. 8, input image data for a remosaic network can be obtained by processing an image of the foreground, an image of the background, and a first mask according to point spread functions for four phases matching depth information of the foreground and point spread functions for four phases matching depth information of the background.

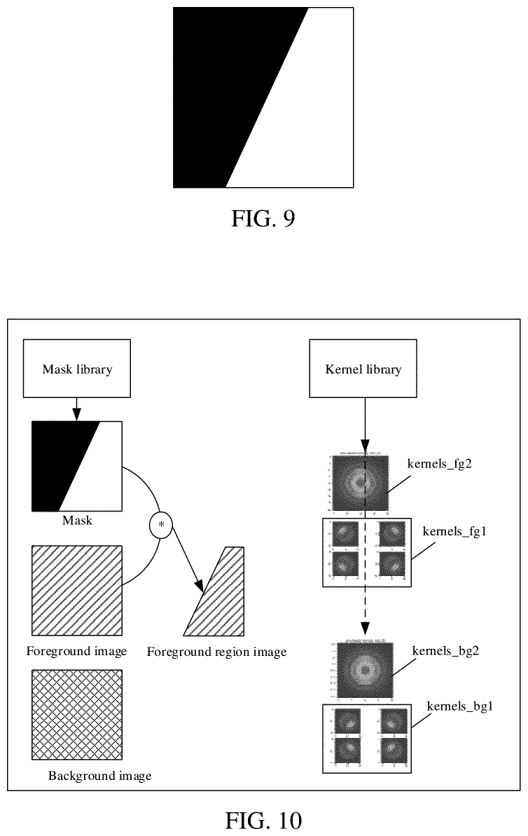

In embodiments of the present disclosure, the first mask may define an occlusion relationship between a foreground and a background, and the first mask may be a binary mask or other type of mask. FIG. 9 is a schematic diagram of a binary mask according to an embodiment of the present disclosure, in which the value of the white portion is 1 and the value of the black portion is 0. The white portion represents the image region in which the foreground exists, that is, the image region in which the foreground needs to be extracted. The black portion represents an image region that does not block the background, that is, an image region that needs to be extracted from the background. The boundary shape of the black portion and the white portion can be considered as the edge shape of the foreground image.

An implementation in which the images of the four phases of the foreground and the images of the four phases of the background are obtained is exemplarily described below.

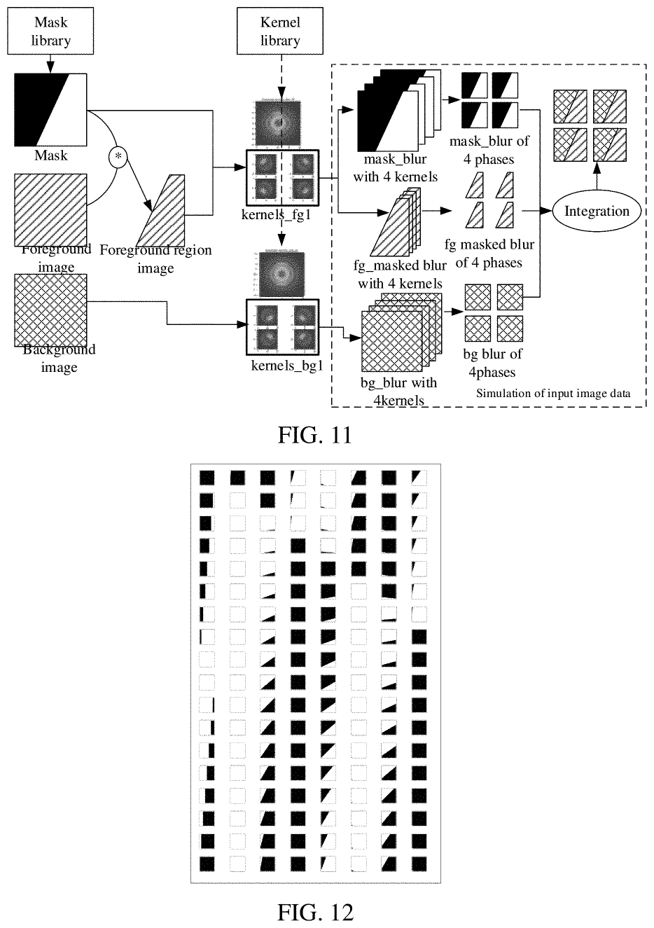

In an implementation, referring to FIGS. 10 and 11, after the foreground image and the mask are determined, a first mask may be used to perform region image extraction on the foreground image to obtain the foreground region image, then, the point spread function kernels for four phases matching the depth information of the foreground may be selected from the pre-established kernel library. In FIGS. 10 and 11, the point spread function kernels for four phases matching the depth information of the foreground may be collectively denoted as kernels_fg1.

In the embodiments of the present disclosure, the mask and the foreground image may be multiplied pixel by pixel to obtain the foreground region image according to the following equation (1):

FG_masked (m)=mask (m)*FG (m) (1)

In Equation (1), the mask (m) represents the pixel value of the m-th pixel in the first mask, and m is an integer greater than or equal to 1. For a binary mask, the value of the mask (m) is 0 or 1. FG (m) represents the pixel value of the m-th pixel of the foreground image, and FG_masked (m) represents the pixel value of the m-th pixel in the region image of the foreground. In the embodiments of the present disclosure, the image size of the first mask is the same as the image size of the foreground image, and the arrangement of the pixels of the first mask is the same as the arrangement of the pixels of the foreground image.

Referring to FIG. 11, after obtaining the foreground region image and the point spread function kernels kernels_fg1 for four phases matching the foreground depth information, the foreground region image can be blurred according to the point spread function kernels kernels_fg1 for four phases matching the foreground depth information to obtain four blurred images corresponding to the foreground region image. In FIG. 11, the four blur images corresponding to the foreground region image may be denoted as “fg_masked blur with 4 kernels”.

After determining the image of the background, referring to FIGS. 10 and 11, the point spread function kernels for four phases matching the depth information of the background can be selected from the pre-established kernel library. In FIGS. 10 and 11, the point spread function kernels for four phases matching the depth information of the background can be denoted as kernels_bg1.

Referring to FIG. 11, after the point spread function kernels kernels_bg1 for four phases matching the depth information of the background are determined, the point spread function kernels kernels_bg1 for four phases matching the depth information of the background can perform blurring processing on the background image, respectively, to obtain four blurred images of the background. In FIG. 11, the four blurred images of the background may be denoted as “bg_blur with 4kernels”.

After obtaining the four blurred images corresponding to the foreground region image and the four blurred images corresponding to the background, referring to FIG. 11, the four blurred images corresponding to the foreground region image can be downsampled to obtain the images of the four phases of the foreground; The four blurred images of the background may also be downsampled to obtain the images of the four phases of the background. In FIG. 11, the images of the four phases of the foreground may be denoted as “fg masked blur of 4 phases”, and the images of the four phases of the background may be denoted as “bg blur of 4phases”.

In another implementation, the point spread function kernels for four phases matching the depth information of the foreground may be selected from the pre-established kernels after the image of the foreground is determined; blurring processing is performed on the foreground image according to the point spread function kernels for the four phases matching the depth information of the foreground to obtain the four blurred images of the foreground. Then, the four blurred images of the foreground are downsampled to obtain the images of the four phases of the foreground.

The point spread function kernels for four phases matching the depth information of the background may be selected from the pre-established kernels after the image of the background is determined. blurring processing is performed on the background image according to point spread function kernels for four phases matching the depth information of the background to obtain four blurred images of the background. Then, the four blurred images of the background are downsampled to obtain the images of the four phases of the background.

It can be seen that due to the point spread functions for four phases matching the depth information of the image of each image layer, the light field distribution information of the image of each image layer can be represented. The images of the four phases of each image layer is obtained by point spread functions for four phases matching the depth information of the image of each image layer, so that the images of the four phases of each image layer are closer to the actually acquired images. Further, the region image is extracted by the first mask from the four-phase images of the at least two image layers, and the extracted images are synthetized, so that the input image data close to the actually acquired image can be obtained, thereby improving the training effect of the neural network.

Exemplarily, down-sampling processing may be performed on the target image (for example, four blurred images corresponding to the foreground region image, four blurred images of the foreground, or four blurred images of the background) according to the following equation (2):

Phase_ij=input[i::2,j::2] (i=0,1;j=0,1) (2)

Here, Phase_ij represents the result obtained by the downsampling process, and the meaning of Equation (2) is that one pixel is taken from each set of two pixels in the horizontal direction of the target image, and at the same time, one pixel is taken from each set of two pixels in the vertical direction of the target image. Since the sampling of the pixel needs to satisfy the sampling rules in both the horizontal direction and the vertical direction, the area of the image obtained by downsampling is ¼ of the area of the target image.

Exemplarily, with reference to FIGS. 10 and 11, the first mask may be selected from a pre-established mask library.

FIG. 12 is a schematic diagram of part of a pre-established mask library according to an embodiment of the present disclosure. Referring to FIG. 12, masks having different edge directions may be pre-established to enhance the diversity of input image data and labeled image data. Although the boundaries between the black portion and the white portion in the masks illustrated in FIG. 12 are linear boundaries, It is to be noted that the first masks of the embodiments of the present disclosure are not limited to the masks illustrated in FIG. 12.

Exemplarily, a first mask may be randomly selected from a pre-established mask library, or a first mask may be selected from a pre-established mask library according to a mask selection instruction from a user.

It can be seen that, in embodiments of the present disclosure, a first mask may be selected from a mask library, that is, a variety of first masks may be provided based on the rich masks in the mask library, so that a large number of different training data for the neural network may be generated by cyclically performing the steps of generating the input image data and labeling the image data, thereby improving the training effect of the neural network.

Exemplarily, the step of obtaining a region image of each image layer performing region image extraction on the sample image of the image layer according to the first masks may include: performing blurring processing on the first masks according to the point spread functions for four phases matching second depth information, obtaining masks for the four phases subjected to the blurring processing, the second depth information representing depth information of each of the at least two image layers; and obtaining a region image of each image layer by performing region image extraction on the sample image of the image layer according to the masks for the four phases.

Explanation will be made below by taking two image layers as an example.

When at least two image layers include a foreground and a background, depth information of the foreground may be determined as second depth information. Referring to FIG. 11, the first masks may be blurred based on the point spread function kernels kernels_fg1 for the four phases matching the second depth information to obtain blurred masks for the four phases. In FIG. 11, the blurred masks for the four phases may be denoted as “mask_blur with 4 kernels”.

After obtaining the masks for the four phases after the blurring processing, referring to FIG. 11, the masks for the four phases after the blurring processing can be downsampled according to the above-mentioned equation (2) to obtain sample images of the masks of the four phases. In FIG. 11, the sample images of the masks of the four phases may be denoted as “mask_blur of 4 phases”.

After obtaining sample images of the masks of the four phases, referring to FIG. 11, the sample image of the mask of the p-th phase, the image of the p-th phase of the foreground, and the image of the p-th phase of the background can be synthesized to obtain the synthesized image of the p-th phase. Thus, the synthesized image of the first phase, the synthesized image of the second phase, the synthesized image of the third phase, the synthesized image of the fourth phase are synthetized into the input image data for the remosaic network, and the value of p is 1, 2, 3, or 4.

Exemplarily, the sample image of the mask of the p-th phase, the image of the p-th phase of the foreground, and the image of the p-th phase of the background may be synthetized pixel-by-pixel to obtain the synthetized image of the p-th phase according to Equation (3):

Output_p=(1−m_b_p)*BG_b_p+FG_m_b_p (3)

Here, Output_p represents the pixel value of the synthetized image of the p-th phase, masked_b_p represents the pixel value of the sample image of the mask of the p-th phase, BG_b_p represents the pixel value of the image of the p-th phase of the background, and FG_m_b_p represents the pixel value of the image of the p-th phase of the foreground.

In some embodiments, the synthetized image of the first phase, the synthetized image of the second phase, the synthetized image of the third phase, the synthetized image of the fourth phase may also be synthesized according to equation (4) to obtain a full resolution image for the purpose of data storage.

Output [i::2,j::2]=Phase_ij (i=0,1;j=0,1) (4)

Here, Output [i:: 2, j:: 2] represents the full resolution image, and the synthesis operation shown in Equation (4) may be considered as a reverse operation of the sampling operation shown in Equation (2), and the area of the full resolution image obtained by Equation (4) is 4 times the synthetized image of each phase.

It is to be noted that the above-mentioned step of image synthesis is an optional step. After obtaining the synthesized image of the first phase, the synthesized image of the second phase, the synthesized image of the third phase, the synthesized image of the fourth phase, the synthesized image of the first phase, the synthesized image of the second phase, the synthesized image of the third phase, the synthesized image of the fourth phase may not be subjected to image synthesis.

It will be appreciated that in an actually acquired image, the boundary between two layers of an image is generally not a completely clear boundary, but rather forms a smooth transition boundary, e.g., the boundary between the foreground and background of image is a smooth transition boundary. In such case, in the embodiments of the present disclosure, the boundaries of different portions of the first mask can be smoothly transitioned by performing blurring process on the first mask, so that the region images of the at least two image layers are respectively extracted based on the blurred masks of the four phases, and the image of the smooth transition between the different image layers can be obtained, that is, the generated input image data is more consistent with the actually acquired image, thereby improving the training effect of the neural network.

Exemplarily, the step of processing the original image according to the complete point spread function to obtain labeled image data may include: performing blurring processing on the image of each of the at least two image layers according to a complete point spread function matching the depth information of the image layer to obtain a preprocessed image of the image layer; and obtaining the labeled image data according to the preprocessed image.

As can be seen, the point spread functions for the four phases matching the depth information of the image of each image layer may represent the light field distribution information of the image of the image layer, and the image of the image layer is obtained according to the point spread functions for the four phases matching the depth information of the image of the image layer, and thus, the image of the image layer is closer to an image as actually captured. As such, it is advantageous to obtain input image data, that is closer to the image as actually captured, by performing blurring processing on an image of each image layer.

Exemplarily, processing the original image according to a complete point spread function to obtain labeled image data may include: performing blurring processing on the image of each of the at least two image layers according to a complete point spread function matching the depth information of the image layer to obtain a preprocessed image of the image layer; and obtaining the labeled image data according to the preprocessed image.

Description will be made below by taking two image layers as an example.

When at least two image layers include a foreground and a background, referring to FIG. 8, the image of the foreground, the image of the background, and the first mask can be processed according to the complete point spread function matching the depth information of the foreground and the complete point spread function matching the depth information of the background, to obtain labeled image data for the remosaic neural network.

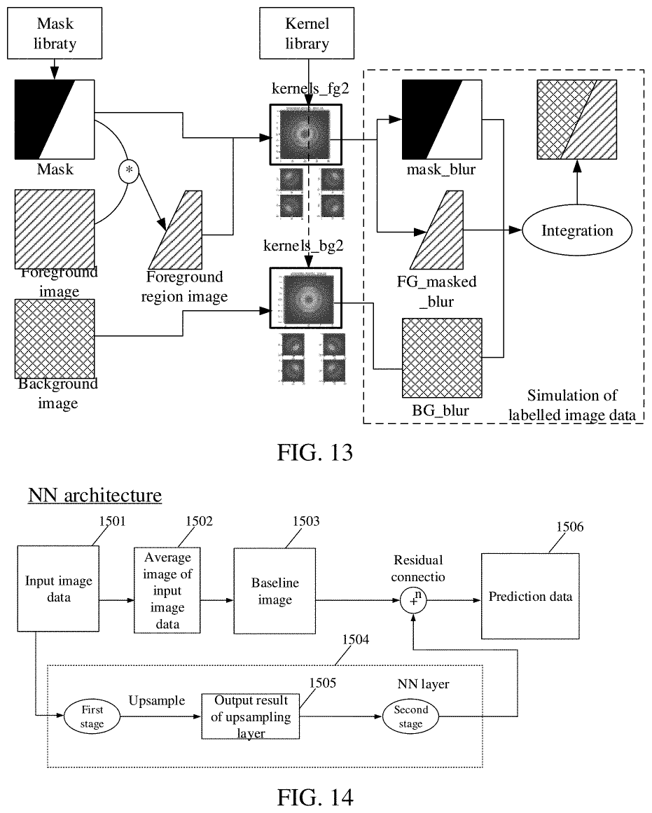

Exemplarily, referring to FIGS. 10 and 13, after obtaining the foreground region image, a complete point spread function kernel that matches the depth information of the foreground may be selected from a pre-established kernel library. In FIGS. 10 and 13, the complete point spread function kernel that matches the depth information of the foreground may be denoted as kernels_fg2. In an embodiment of the present disclosure, the point spread function kernels kernels_fg1 of four phases and the complete point spread function kernel kernels_fg2 belong to the same group of kernels, and they all match with the same foreground depth information.

Referring to FIG. 13, after obtaining the complete point spread function kernel kernels_fg2 that matches the foreground depth information, the foreground region image may be subjected to blurring processing according to the complete point spread function kernel kernels_fg2 that matches the foreground depth information to obtain the foreground preprocessed image. In FIG. 13, the image after the preprocessing of the foreground may be denoted as FG_masked_blur.

After determining the image of the background, referring to FIGS. 10 and 13, the complete point spread function kernel matching the depth information of the background can be selected from the pre-established kernel library. In FIGS. 10 and 13, the complete point spread function kernel matching the depth information of the background can be denoted as kernels_bg2.

Referring to FIG. 13, after determining the complete point spread function kernel kernels_bg2 that matches the depth information of the background, the image of the background may be subjected to blurring processing according to the complete point spread function kernel kernels_bg2 that matches the depth information of the background to obtain the preprocessed image of the background. In FIG. 13, the preprocessed image of the background may be denoted as BG_blur.

It can be seen that due to the complete point spread function matching the depth information of the image of each image layer, the light field distribution information of the image of each image layer can be represented. Moreover, the preprocessed image of each image layer is obtained according to a complete point spread function that matches the depth information of the image of each image layer. Therefore, the preprocessed image of each image layer is closer to the actually acquired image. Further, the region image is extracted by the first mask from the preprocessed image of the at least two image layers, and the extracted images are synthetized, so that the labeled image data close to the actually acquired image can be obtained, thereby improving the training effect of the neural network.

Exemplarily, the step of performing region image extraction on the pre-processed image of each image layer according to the first mask to obtain a region image corresponding to the image layer may include: performing blurring processing on the first mask according to a complete point spread function matching the second depth information to obtain a second mask subjected to the blurring processing, the second depth information representing depth information of each of the at least two image layers; and obtaining a region image of each image layer by performing region image extraction on the preprocessed image of the image layer according to the second mask.

Description will be made below by taking two image layers as an example.

When at least two image layers include a foreground and a background, depth information of the foreground may be determined as second depth information. Referring to FIG. 13, the first mask may be blurred according to the complete point spread function kernel kernels_fg2 that matches the second depth information to obtain a blurred second mask. In FIG. 13, the second mask may be denoted as mask_blur.

Referring to FIG. 13, after obtaining the blurred second mask mask_blur, the second mask, the preprocessed foreground image, and the preprocessed background image may be synthesized to obtain labeled image data for the remosaic network.

Exemplarily, the second mask, the foreground pre-processed image, and the background pre-processed image may be synthesized pixel-by-pixel according to Equation (5) to obtain labeled image data for the remosaic network:

Output_1×1OCL=(1−m_b)*BG_b+FG_m_b (5)

Here, Output_1×1OCL represents the pixel value in the labeled image data for the remosaic network, m_b represents the pixel value of the second mask subjected blurring processing, BG_b represents the pixel value in the pre-processed image of the background, and FG_m_b represents the pixel value of the pre-processed image of the foreground.

It will be appreciated that in an actually acquired image, the boundary between two image layers is generally not a perfectly clear boundary, but rather forms a smooth transition boundary, e.g., the boundary between the foreground and background of an image is a smooth transition boundary. In such case, in the embodiments of the present disclosure, the boundaries of different portions of the second mask can be smoothly transitioned by blurring the first mask, so that the region images of the at least two image layers are respectively extracted based on the second mask, and the image of the smooth transition between the different image layers can be obtained, that is, the generated labeled image data is more consistent with the actually acquired image, thereby improving the training effect of the neural network.

As can be seen from the above description, in some embodiments of the present disclosure, a forward imaging model for generating input image data and labeled image data based on the acquired point spread functions is proposed, and the input image data and labeled image data that meet the needs of the user can be generated if the foreground image, the background image, and the first mask are specified by the user.

In an embodiment of the present disclosure, an image having a quad bayer array captured by 2×2 OCL sensors is processed by using a remosaic network for removing a phase difference from the image. In case of remosaicing an image, an upsampling neural network may be designed in the remosaic network. Exemplarily, the upsampling neural network may include a residual network to which input image data for the upsampling neural network may be input in a practical application. Input image data may be processed by a residual network to obtain prediction data. Then, the network parameter value of the residual network may be adjusted according to the prediction data and the labeled image data, thereby realizing the training of the upsampling neural network.

In a residual network, a task of a neural network is simplified by providing a baseline image, such that the neural network learns only the residual, and thus the accuracy of the neural network can be improved.

Exemplarily, in an implementation of processing input image data using a residual network, the average image of the input image data is ups ampled to obtain a baseline image, the input image data is processed through the neural network layer of the residual network to obtain the output data of the neural network layer. The neural network layer includes at least a convolution layer and an upsampling layer. Based on the residual connection, the baseline image and the output data of the neural network layer are added to obtain prediction data.

In the neural network layer of the residual network, the convolution layer may be used to extract features, and the up-sampling layer may be used to up-sample the features; The output data of the neural network layer may be in the form of features or feature maps.

The structure of a residual network in an embodiment of the present disclosure will be illustrated with reference to the accompanying drawings.

Referring to FIG. 14, an average image 1502 of the input image data can be obtained by averaging the input image data 1501 according to color channels. Then, the average image 1502 of the input image data can be bilinear upsampled to obtain a baseline image 1503.

Referring to FIG. 14, the input image data 1501 are input to the neural network layer 1504 of the residual network. Here, each RGB image of the input image data 1501 includes an image of R channel, an image of G channel, and an image of B channel, that is, the input data of the residual network is the RGB images of the 12 channels.

The process of performing image processing at the neural network layer 1504 of the residual network may be separated into at least a stage 1, an upsampling stage, and a stage 2. The stage 1 is used for feature extraction by using the convolutional layer, and the input data of the convolutional layer used in the stage 1 is the input image data 1501, and the data amount of the RGB image corresponding to each sub-image is smaller than that of the to-be-processed image having the quad Bayer RGB array, so that the operation of the convolutional layer in the stage 1 can be realized at a lower calculation cost.

After the stage 1, the output result of the stage 1 can be upsampled by the using upsampling layer to obtain the output result 1505 of the upsampling layer.

In the stage 2, features smoothing process between the four phases can be performed on the output result 1505 of the upsampling layer through the convolutional layer, such that the processing quality of the image can be improved. The output data after stage 2 is the output data of the neural network layer.

After the baseline image and the output data of the neural network layer are obtained, the baseline image and the output data of the neural network layer can be added based on the residual connection to obtain the prediction data 1506. The prediction data 1506 is an RGB image, and the height and the width of the prediction data 1506 are both twice the RGB image corresponding to the input image data 1501.

The execution results of the remosaic task by a first method and a second method may be compared in the embodiments of the present disclosure, Here, the first method represents a method of training a remosaic network using a dataset of an actually acquired image and performing the remosaic task according to the completed remosaic network. The second method represents a method of generating training data of a remosaic network using the method described in the present disclosure embodiment, training the remosaic network using the training data, and performing a remosaic task according to the completed remosaic network.

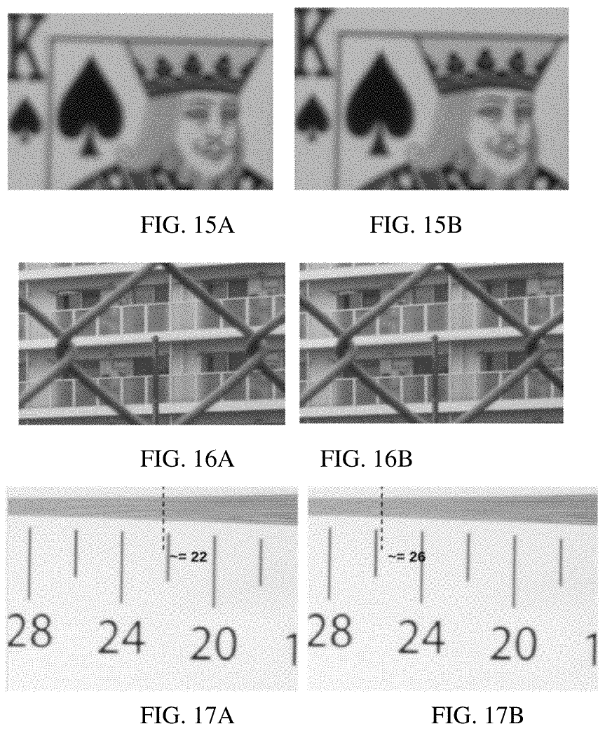

FIGS. 15A and 15B are schematic diagrams of execution results of remosaic tasks for playing cards by the first and second methods, respectively, according to embodiments of the present disclosure. FIGS. 16A and 16B are schematic diagrams of execution results of a remosaic task for a building obtained by a first and second methods, respectively, according to an embodiment of the present disclosure. By comparing FIG. 15A with FIG. 15B, and by comparing FIG. 16A with FIG. 16B, it can be seen that the execution results of the remosaic task are similar by performing the first and second methods, which may illustrate the validity of the training data generated in the embodiments of the present disclosure.

FIGS. 17A and 17B are schematic diagrams of the highest resolution of the output image (for characterizing the ability to recover dense lines) in the case of processing challenging data using the first and second methods. By comparing FIGS. 17A and 17B, it can be seen that the highest resolution of the output image by performing the first method is approximately 22 and the highest resolution of the output image by performing the second method is approximately 26, which shows that in the case of processing challenging data, a better effect can be achieved by performing the remosaic task using the method described in the embodiments of the present disclosure as compared with the first method.

It will be appreciated that training data is important for the success of any data-driven method including deep learning. However, in the related art, high labor and time cost are required to obtain high-quality labeled image data, and in order to improve the training effect of the neural network, input image data (e.g., image with complex texture) that is difficult to process for neural network is required to be obtained. In practical scenarios, input image data that is difficult to process for a neural network is generally difficult to obtain in large quantities. In the embodiments of the present disclosure, the original image may be processed according to point spread functions for four phases that match the depth information of the original image and a complete point spread function to obtain the input image data and the labeled image data for the neural network, that is, a pair of the input image data and the labeled image data may be easily obtained in the embodiment of the present disclosure, and the training data may be obtained without completely relying on real images collected by a 2×2 OCL sensor, thereby saving the labor cost and the time cost for obtaining the training data.

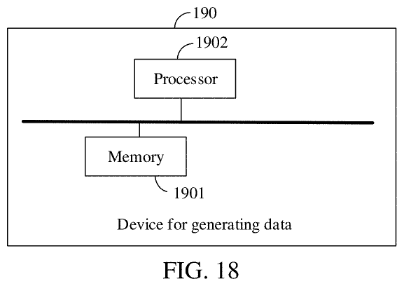

Based on the same technical concept of the foregoing embodiment, referring to FIG. 18, a device for generating data 190 provided in an embodiment of the present disclosure may include a memory 1901 and a processor 1902.

The memory 1901 is used for storing a computer program and data. The processor 1902 is configured to execute the computer program stored in the memory to implement any one of the methods for generating data of the foregoing embodiments.

In practical applications, the memory 1901 may be a volatile memory, such as a Random Access Memory (RAM); or a non-volatile memory such as a Read-Only Memory (ROM), a flash memory, a Hard Disk Drive (HDD) or a Solid-State Drive (SSD); or a combination of memories as described above; and the memory 1901 provides instructions and data to the processor 1902.

The processor 1902 may be at least one of an ASIC, a DSP, a DSPD, a PLD, an FPGA, a CPU, a controller, a microcontroller, and a microprocessor. It will be appreciated that for different devices, the electronics for implementing the above-described processor functions may be other devices, and the embodiments of the present disclosure are not specifically limited.

The computer program instructions corresponding to the method for generating data in the present embodiment may be stored on a storage medium such as an optical disk, a hard disk, or a USB flash disk. When the computer program instructions corresponding to the sensitivity difference correction method in the storage medium is read or executed by an electronic device, any of the methods for generating data in the foregoing embodiments is implemented.

In some embodiments, the devices provided by the embodiments of the present disclosure may have functions or include modules for performing the methods described in the above method embodiments, and specific implementations thereof may be described with reference to the above method embodiments, and details are not described herein for brevity.

The foregoing description of the various embodiments is intended to emphasize differences between the various embodiments, the same or similar may be referred to each other, and details are not described herein for the sake of brevity.

The methods disclosed in the various method embodiments provided herein can be combined arbitrarily without conflict to obtain new method embodiments.

The features disclosed in the various product embodiments provided herein can be combined arbitrarily without conflict to obtain new product embodiments.

The features disclosed in each method or apparatus embodiment provided in the present application may be combined arbitrarily without conflict to obtain a new method embodiment or apparatus embodiment.

From the above description of the embodiments, it will be apparent to those skilled in the art that the method of the above embodiments may be implemented by means of software plus the necessary general hardware platform, but may be implemented by means of hardware, but in many cases the former is the preferred embodiment. Based on such an understanding, the technical solution of the present disclosure, in essence or in portion contributing to the prior art, may be embodied in the form of a software product stored in a storage medium (such as a ROM/RAM, a magnetic disk, or an optical disk) including instructions for causing a terminal (which may be a mobile phone, a computer, a server, an air conditioner, or a network device) to perform the methods described in the various embodiments of the present disclosure.

Embodiments of the present disclosure have been described above in conjunction with the accompanying drawings, but the present disclosure is not limited to the foregoing detailed description, which is merely illustrative and not restrictive, and many forms may be made by those ordinary skilled in the art without departing from the spirit of the disclosure and the scope of the claims, all of which are within the protection of the disclosure.

1. A method for generating data, comprising:
obtaining an original image;
determining first depth information of the original image;
determining point spread functions for four phases matching the first depth information and a complete point spread function matching the first depth information, wherein the point spread functions for the four phases represent light field distribution information of images of the four phases acquired using the 2×2 On-Chip Lens (OCL) sensor, and the complete point spread function represents light field distribution information of an image acquired using the imaging sensor when there are one-to-one correspondences between pixels and lenses of the imaging sensor;
processing the original image according to the point spread functions for the four phases to obtain input image data, and processing the original image according to the complete point spread function to obtain labeled image data; and
determining the input image data and the labeled image data as training data for training a neural network.

2. The method of claim 1, wherein the obtaining an original image comprises:
determining at least two image layers having different depth information;
selecting an image having the at least two image layers from a pre-established image library; and
determining the image having the at least two image layers as the original image.

3. The method of claim 2, wherein the processing the original image according to the point spread functions for the four phases to obtain input image data comprises:
performing blurring processing on an image of each of the at least two image layers according to the point spread functions for four phases matching the depth information of the image layer to obtain four blurred images of the image layer; and
obtaining the input image data according to four blurring images of each image layer.

4. The method of claim 3, wherein the obtaining the input image data according to four blurring images of each image layer comprises:
obtaining a sample image of the image layer by sampling the four blurred images;
selecting a first mask from a pre-established mask library, and obtaining a region image of each image layer by performing region image extraction on the sample image of the image layer according to the first mask; and
obtaining the input image data by synthetizing the region images of at least two image layers.

5. The method of claim 4, wherein the obtaining a region image of each image layer performing region image extraction on the sample image of the image layer according to the first masks comprises:
performing blurring processing on the first masks according to the point spread functions for four phases matching second depth information, obtaining masks for the four phases subjected to the blurring processing, the second depth information representing depth information of each of the at least two image layers; and
obtaining a region image of each image layer by performing region image extraction on the sample image of the image layer according to the masks for the four phases.

6. The method of claim 2, wherein the processing the original image according to the complete point spread function to obtain labeled image data comprises:
performing blurring processing on the image of each of the at least two image layers according to a complete point spread function matching the depth information of the image layer to obtain a preprocessed image of the image layer; and
obtaining the labeled image data according to the preprocessed image.

7. The method of claim 6, wherein the obtaining the labeled image data according to the preprocessed image comprises:
selecting a first mask from a pre-established mask library, and obtaining a region image of each image layer by performing region image extraction on the preprocessed image of the image layer according to the first mask; and
obtaining the labeled image data by synthetizing the region images of at least two image layers.

8. The method of claim 7, wherein the obtaining a region image of each image layer by performing region image extraction on the preprocessed image of the image layer according to the first mask comprises:
performing blurring processing on the first mask according to a complete point spread function matching second depth information to obtain a second mask subjected to the blurring processing, the second depth information representing depth information of each of the at least two image layers; and
obtaining a region image of each image layer by performing region image extraction on the preprocessed image of the image layer according to the second mask.

9. The method of claim 2, wherein before determining the at least two image layers having different depth information, the method further comprises: randomly determining depth information of each of the at least two image layers.

10. A device for generating data, comprising:
a processor; and
a memory for storing instructions executable by the processor,
wherein the processor is configured to:
obtain an original image;
determine first depth information of the original image;
determine point spread functions for four phases matching the first depth information and a complete point spread function matching the first depth information, wherein the point spread functions for four phases represent light field distribution information of images of the four phases acquired using the 2×2 On-Chip Lens (OCL) sensor, and the complete point spread function represents light field distribution information of an image acquired using the imaging sensor when there are one-to-one correspondences between pixels and lenses of the imaging sensor;
process the original image according to the point spread functions for the four phases to obtain input image data, and process the original image according to the complete point spread function to obtain labeled image data; and
determine the input image data and the labeled image data as training data for training a neural network.

11. The device of claim 10, wherein the processor is further configured to execute the instructions to:
determining at least two image layers having different depth information, selecting an image having the at least two image layers from a pre-established image library, and determining the image having the at least two image layers as the original image.

12. The device of claim 11, wherein the processor is further configured to execute the instructions to:
perform blurring processing on an image of each of the at least two image layers according to the point spread functions for the four phases matching the depth information of the image corresponding to the image layer to obtain four blurred images of the image layer; and
obtain the input image data according to four blurring images of each image layer.

13. The device of claim 12, wherein the processor is further configured to execute the instructions to:
obtain a sample image of the image layer by sampling the four blurred images;
select a first mask from a pre-established mask library, and obtain a region image of each image layer by performing region image extraction on the sample image of the image layer according to the first mask; and
obtain the input image data by synthetizing the region images of at least two image layers.

14. The device of claim 13, wherein the processor is further configured to execute the instructions to:
perform blurring processing on the first masks according to the point spread functions for the four phases matching second depth information, obtain masks for the four phases subjected to the blurring processing, the second depth information representing depth information of each of the at least two image layers; and
obtaining a region image of each image layer by performing region image extraction on the sample image of the image layer according to the masks for the four phases.

15. The device of claim 11, wherein the processor is further configured to execute the instructions to:
perform blurring processing on the image of each of the at least two image layers according to a complete point spread function matching the depth information of the image layer to obtain a preprocessed image of the image layer; and
obtain the labeled image data according to the preprocessed image.

16. The device of claim 15, wherein the processor is further configured to execute the instructions to:
select a first mask from a pre-established mask library, and obtain a region image of each image layer by performing region image extraction on the preprocessed image of the image layer according to the first mask; and
obtain the labeled image data by synthetizing the region images of at least two image layers.

17. The device of claim 16, wherein the processor is further configured to execute the instructions to:
perform blurring processing on the first mask according to a complete point spread function matching second depth information to obtain a second mask subjected to the blurring processing, the second depth information representing depth information of each of the at least two image layers; and
obtain a region image of each image layer by performing region image extraction on the preprocessed image of the image layer according to the second mask.

18. The device of claim 11, wherein the processor is further configured to execute the instructions to:
before determining the at least two image layers having different depth information, randomly determine depth information of each of the at least two image layers.

19. A non-transitory computer storage medium having stored thereon a computer program which, when executed by a processor, executes a method for generating data, the method comprising:
obtaining an original image;
determining first depth information of the original image;
determining point spread functions for four phases matching the first depth information and a complete point spread function matching the first depth information, wherein the point spread functions for the four phases represent light field distribution information of images of the four phases acquired using the 2×2 On-Chip Lens (OCL) sensor, and the complete point spread function represents light field distribution information of an image acquired using the imaging sensor when there are one-to-one correspondences between pixels and lenses of the imaging sensor;
processing the original image according to the point spread functions for the four phases to obtain input image data, and processing the original image according to the complete point spread function to obtain labeled image data; and
determining the input image data and the labeled image data as training data for training a neural network.

20. The non-transitory computer storage medium of claim 19, wherein the obtaining an original image comprises:
determining at least two image layers having different depth information;
selecting an image having the at least two image layers from a pre-established image library; and
determining the image having the at least two image layers as the original image.
